(19) United States
(12) Patent Application Publication
(10) Pub. No.: US 2015/0135828 A1
(43) Pub. Date: May 21, 2015

(54) SYSTEM FOR MEASURING FLUID LEVEL

(71) Applicant: Ford Global Technologies, LLC, Dearborn, MI (US)

(72) Inventors: Stuart C. Salter, White Lake, MI (US); James J. Surman, Clinton Township, MI (US)

(21) Appl. No.: 14/508,700

(22) Filed: Oct. 7, 2014

Related U.S. Application Data
(63) Continuation-in-part of application No. 14/322,450, filed on Jul. 2, 2014.
Application No. 14/322,450 is a continuation-in-part of application No. 14/301,635, filed on Jun. 11, 2014.
Application No. 14/301,635 is a continuation-in-part of application No. 14/156,869, filed on Jan. 16, 2014.
Application No. 14/156,869 is a continuation-in-part of application No. 14/086,442, filed on Nov. 21, 2013.

(51) Int. Cl. G01F 23/04; G01F 23/292

(52) U.S. Cl. CPC G01F 23/04; G01F 23/292
USPC 73/293

(57) ABSTRACT

A system for measuring fluid level is provided. The system includes a dipstick configured to be received in a fluid reservoir and having a photoluminescent portion. The system also includes a light source operable to emit a first light to excite the photoluminescent portion. A fluid level is determined based on a degree of illumination of the photoluminescent portion when the dipstick is removed from the reservoir and the photoluminescent portion is exposed to the first light.

### CROSS-REFERENCE TO RELATED APPLICATIONS

This application is a continuation-in-part of U.S. patent application Ser. No. 14/322,450 filed Jul. 2, 2014, and entitled “PHOTOLUMINESCENT ENGINE COMPARTMENT LIGHTING,” which is a continuation-in-part of U.S. patent application Ser. No. 14/301,635, filed Jun. 11, 2014, and entitled “PHOTOLUMINESCENT VEHICLE READING LAMP,” which is a continuation-in-part of U.S. patent application Ser. No. 14/156,869, filed on Jan. 16, 2014, entitled “VEHICLE DOME LIGHTING SYSTEM WITH PHOTOLUMINESCENT STRUCTURE,” which is a continuation-in-part of U.S. patent application Ser. No. 14/086,442, filed Nov. 21, 2013, and entitled “VEHICLE LIGHTING SYSTEM WITH PHOTOLUMINESCENT STRUCTURE.” The aforementioned related applications are hereby incorporated by reference in their entirety.

### FIELD OF THE INVENTION

The present disclosure generally relates to systems for measuring fluid level, and more particularly to systems that utilize a dipstick as the measuring device.

### BACKGROUND OF THE INVENTION

Measuring fluid levels with a dipstick can be challenging. In some circumstances, it can be difficult to see the fluid on the dipstick. By providing a dipstick with photoluminescent properties, such difficulties can be overcome.

### SUMMARY OF THE INVENTION

According to one aspect of the present invention, a system for measuring fluid level is provided. The system includes a dipstick configured to be received in a fluid reservoir and having a photoluminescent portion. The system also includes a light source operable to emit a first light to excite the photoluminescent portion. A fluid level is determined based on a degree of illumination of the photoluminescent portion when the dipstick is removed from the reservoir and the photoluminescent portion is exposed to the first light.

According to another aspect of the present invention, a dipstick is provided. The dipstick is configured to be received in a fluid reservoir and includes a handle and a shaft extending from the handle. The shaft includes a photoluminescent portion configured to illuminate when excited by a first light. A fluid level of the reservoir is determined based on a degree of illumination of the photoluminescent portion when the dipstick is removed from the reservoir and the photoluminescent portion is exposed to the first light.

According to yet another aspect of the present invention, a method of measuring a fluid level in a fluid reservoir is provided. The method includes the steps of providing a dipstick having a photoluminescent portion configured to illuminate when excited by a first light; receiving the photoluminescent portion in the reservoir; removing the photoluminescent portion from the reservoir; exposing the photoluminescent portion to the first light; and determining the fluid level based on a degree of illumination of the photoluminescent portion.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A illustrates a photoluminescent structure coupled to a support member, according to one embodiment;

FIG. 1B illustrates a photoluminescent structure coupled to a support member, according to another embodiment;

FIG. 1C illustrates a photoluminescent structure coupled to a support member, according to yet another embodiment;

FIGS. 2 and 3 illustrate a system for measuring fluid level and show a cross-sectional view of a fluid reservoir in which a dipstick is received and a cross-sectional view of the fluid reservoir from which the dipstick is removed and exposed to a light source, respectively;

FIGS. 4 and 5 illustrate a system for measuring the oil level of a vehicle engine;

FIG. 6 illustrates one embodiment of a dipstick and a tube that is coupled to a vehicle oil reservoir;

FIG. 7 illustrates a dipstick that indicates a normal oil level; and

FIG. 8 illustrates a dipstick that indicates a low oil level.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure generally relates to a system for measuring a fluid level of a fluid reservoir. The system advantageously employs one or more photoluminescent structures configured to convert light received from an associated light source and re-emit the light at a different wavelength typically found in the visible spectrum. The converted light outputted from the photoluminescent structure(s) may function as task, ambient, and/or accent lighting. While the system described herein is implemented in an automotive vehicle, it will be appreciated that the system may be similarly utilized in non-automotive applications.

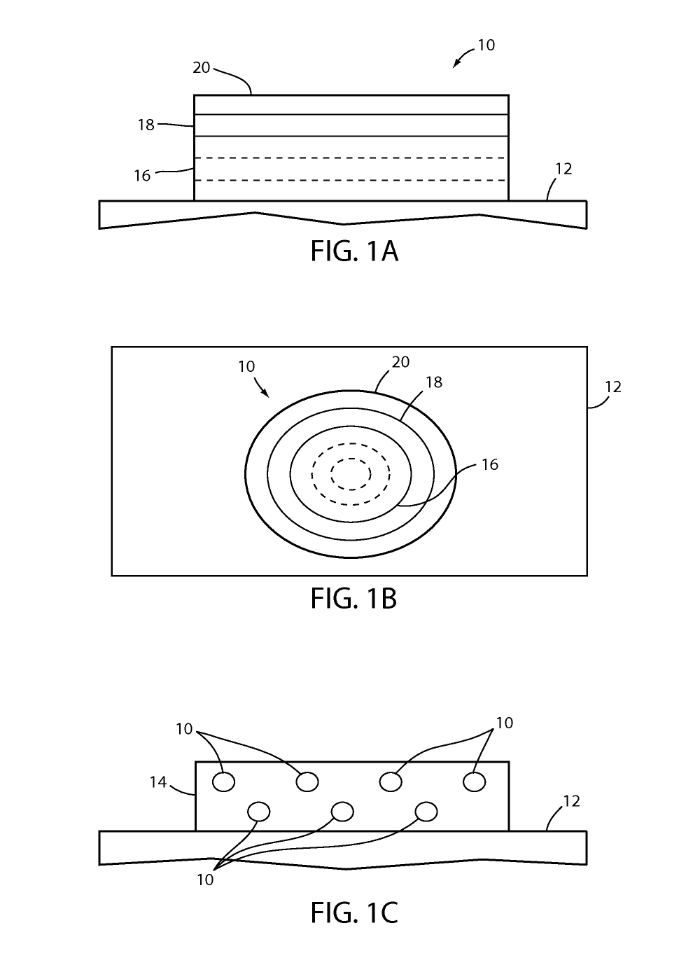

Referring to FIGS. 1A-1C, various exemplary embodiments of a photoluminescent structure 10 are shown, each capable of being coupled to a support member 12, which may correspond to a vehicle fixture or a vehicle related piece of equipment. In FIG. 1A, the photoluminescent structure 10 is generally shown rendered as a coating (e.g. a film) that may be applied to a surface of the support member 12. In FIG. 1B, the photoluminescent structure 10 is generally shown as a discrete particle capable of being integrated with a support member 12. In FIG. 1C, the photoluminescent structure 10 is generally shown as a plurality of discrete particles that may be incorporated into a support medium 14 (e.g. a film) that may then be applied (as shown) or integrated to the support member 12.

At the most basic level, a given photoluminescent structure 10 includes an energy conversion layer 16 that may include one or more sub layers, which are exemplarily shown through broken lines in FIGS. 1A and 1B. Each sub layer of the energy conversion layer 16 may include one or more photoluminescent materials having energy converting elements with phosphorescent or fluorescent properties. Each photoluminescent material may become excited upon receiving light of a specific wavelength, thereby causing the light to undergo a conversion process. Under the principle of down conversion, the light is converted into a longer wavelength light, which may then be outputted from the photoluminescent structure 10 and/or used to excite other photoluminescent material(s) found in the energy conversion layer 16. Conversely, under the principle of up conversion, the light is converted into a shorter wavelength light, which may also be outputted from the photoluminescent structure 10 and/or used to excite other photoluminescent material(s) found in the energy conversion layer 16. The process of using converted light outputted from one photoluminescent material to excite another, and so on, is generally known as an energy cascade. With respect to either conversion principle, the difference in wavelength between the light that excites and the converted light is known as the Stokes shift and serves as the principle driving mechanism for an energy conversion process corresponding to a change in wavelength of light. In the various implementations discussed herein, each of the photoluminescent structures may operate under either conversion principle.

The energy conversion layer 16 may be prepared by dispersing the photoluminescent material in a polymer matrix to form a homogenous mixture using a variety of methods. Such methods may include preparing the energy conversion layer 16 from a formulation in a liquid carrier medium and coating the energy conversion layer 16 to a desired support member. The energy conversion layer 16 may be applied to a support member by painting, screen-printing, spraying, slot coating, dip coating, roller coating, bar coating, or any other suitable means. Alternatively, the energy conversion layer 16 may be prepared by methods that do not use a liquid carrier medium. For example, the energy conversion layer 16 may be rendered by dispersing the photoluminescent material into a solid state solution (homogenous mixture in a dry state) that may be incorporated in a polymer matrix, which may be formed by extrusion, injection molding, compression molding, calendaring, thermoforming, etc. The energy conversion layer 16 may then be integrated into a support member using any methods known to those skilled in the art. When the energy conversion layer 16 includes sub layers, each sub layer may be sequentially coated to form the energy conversion layer 16. Alternatively, the sub layers can be separately prepared and later laminated or embossed together to form the energy conversion layer 16. Alternatively still, the energy conversion layer 16 may be formed by coextruding the sub layers.

Referring back to FIGS. 1A and 1B, the photoluminescent structure 10 may optionally include at least one stability layer 18 to protect the photoluminescent material contained within the energy conversion layer 16 from photolytic and thermal degradation. The stability layer 18 may be configured as a separate layer optically coupled and adhered to the energy conversion layer 16. Alternatively, the stability layer 18 may be integrated with the energy conversion layer 16. The photoluminescent structure 10 may also optionally include a protection layer 20 optically coupled and adhered to the stability layer 18 or other layer (e.g. the conversion layer 16 in the absence of the stability layer 18) to protect the photoluminescent structure 10 from physical and chemical damage arising from environmental exposure. The stability layer 18 and/or the protective layer 20 may be combined with the energy conversion layer 16 through sequential coating or printing of each layer, sequential lamination or embossing, or any other suitable means.

Additional information regarding the construction of photoluminescent structures is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Jul. 31, 2012, the entire disclosure of which is incorporated herein by reference. For additional information regarding fabrication and utilization of photoluminescent materials to achieve various light emissions, refer to U.S. Pat. No. 8,207,511 to Bortz et al., entitled “PHOTOLUMINESCENT FIBERS, COMPOSITIONS AND FABRICS MADE THEREFROM,” filed Jun. 26, 2012; U.S. Pat. No. 8,247,761to Agrawal et al., entitled “PHOTOLUMINESCENT MARKINGS WITH FUNCTIONAL OVERLAYERS,” filed Aug. 21, 2012; U.S. Pat. No. 8,519,359 B2 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Aug. 27, 2013; U.S. Pat. No. 8,664,624 B2 to Kingsley et al., entitled “ILLUMINATION DELIVERY SYSTEM FOR GENERATING SUSTAINED SECONDARY EMISSION,” filed Mar. 4, 2014; U.S. Patent Publication No. 2012/0183677 to Agrawal et al., entitled “PHOTOLUMINESCENT COMPOSITIONS, METHODS OF MANUFACTURE AND NOVEL USES,” filed Jul. 19, 2012; U.S. Patent Publication No. 2014/0065442 Al to Kingsley et al., entitled “PHOTOLUMINESCENT OBJECTS,” filed Mar. 6, 2014; and U.S. Patent Publication No. 2014/0103258 A1 to Agrawal et al., entitled “CHROMIC LUMINESCENT COMPOSITIONS AND TEXTILES,” filed Apr. 17, 2014, all of which are included herein by reference in their entirety.

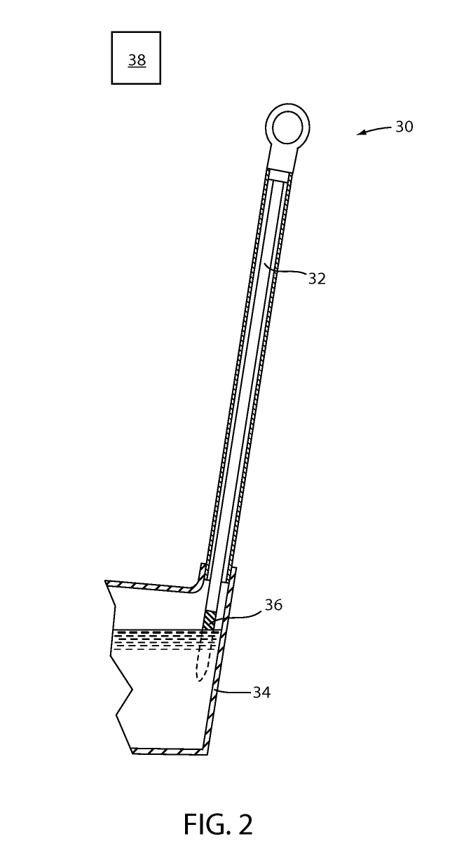

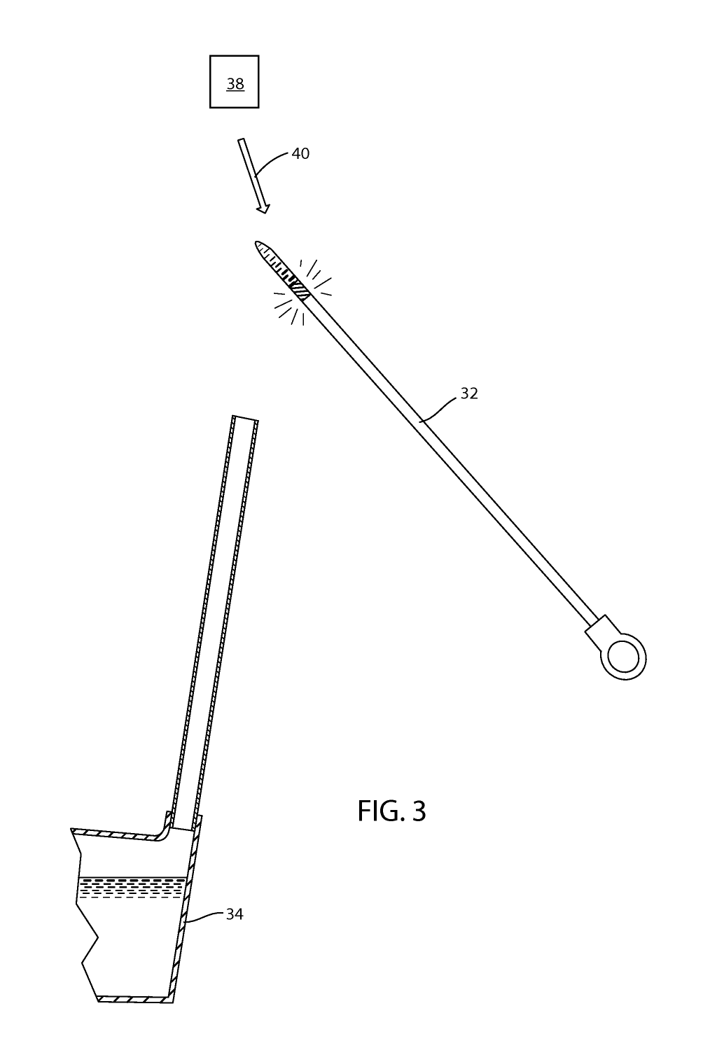

Referring to FIGS. 2 and 3, a system 30 for measuring fluid level is generally shown according to one embodiment. The system 30 includes a dipstick 32 configured to be received in a fluid reservoir 34 and having a photoluminescent portion 36. The system 30 may include a light source 38 operable to emit a first light 40 to excite the photoluminescent portion 36. A fluid level of the reservoir 34 is determined based on a degree of illumination of the photoluminescent portion 36 when the dipstick 32 is removed from the reservoir 34 and the photoluminescent portion 36 is exposed to the first light 40.

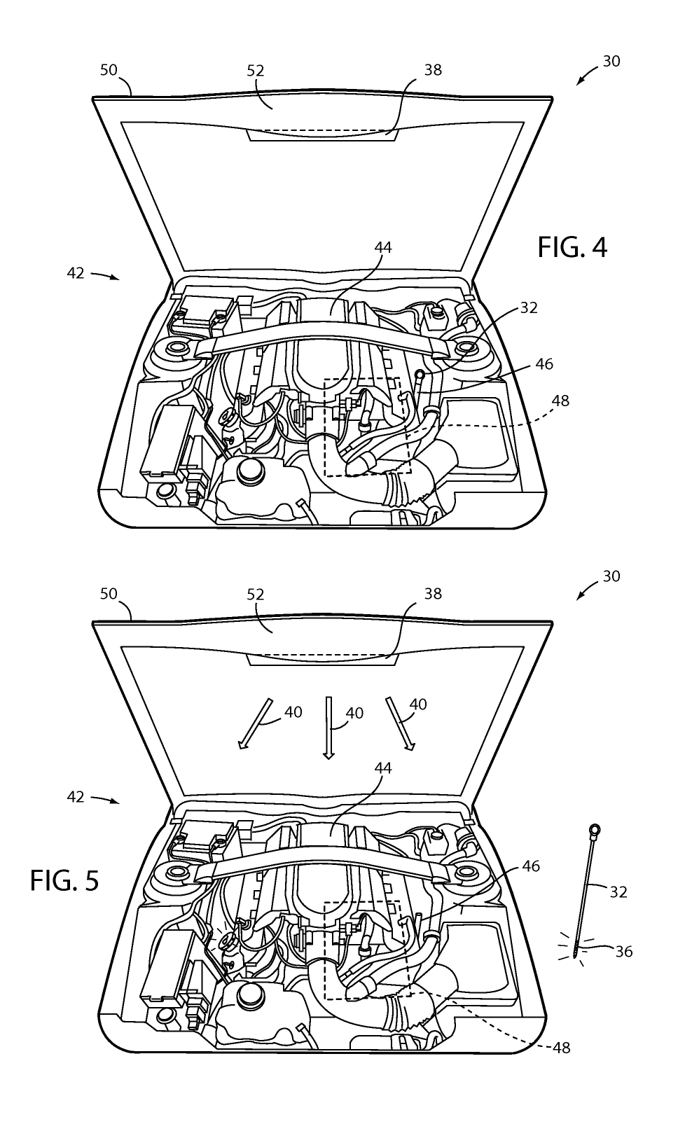

Referring to FIGS. 4 and 5, the system 30 is shown implemented in a vehicle engine compartment 42. According to one implementation, the dipstick 32 may be used to measure an oil level inside a vehicle engine 44. Typically, this is done by inserting the dipstick 32 through a tube 46 that feeds into an oil reservoir 48 of the vehicle engine 44. Once fully inserted, the dipstick 32 comes into contact with the oil contained inside the reservoir 48. The dipstick 32 is then removed from the tube 46 and the oil level is determined based on the extent in which the oil covers the dipstick 32. In some circumstances, it may be difficult to see the oil level on the dipstick 32. For example, in poor visibility conditions, the oil level may be especially difficult to locate. Such poor visibility conditions may be caused by lack of lighting and/or certain characteristics (e.g. consistency, color, etc.) of the oil itself. By providing the photoluminescent portion 36 on the dipstick 32, a user may more easily determine the oil level by simply observing the luminosity of the photoluminescent portion 36 when exposed to the first light 40 emitted from the activated light source 38 (FIG. 3).

The light source 38 may be positioned under a vehicle hood 50 and configured to illuminate the vehicle engine compartment 42 when the vehicle hood 50 is in an open position. The light source 38 may be arranged as a strip and may be powered using a vehicle power supply. Additionally, the light source 38 may include one or more light emitting diodes (LED) and may also include optics configured to disperse or focus the first light 40 being emitted therefrom. The light source 38 may be located in a forward portion 52 of the hood 50 to reduce the amount of heat exposure during operation of the vehicle. Additionally, when the hood 50 is closed, the light source 38 may be located proximate a radiator or other cooling source so that the light source 38 is not damaged by heat radiating from the engine 44.

To determine the oil level of the engine 44, a user must first remove the dipstick 32 from the tube 46 and orient the dipstick 32 so that the first light 40 is directed at the photoluminescent portion 36. The degree in which the photoluminescent portion 36 illuminates is controlled by the amount of oil that covers it. Generally, the luminosity of the photoluminescent portion 36 will be reduced if covered by oil due to the oil interfering with the transmission of the first light 40 to the photoluminescent portion 36. Substantial interference may occur in instances where the photoluminescent portion 36 is covered by oil that is darkened, resulting in little to no illumination. Recognizing this, the photoluminescent portion 36 may be located on the dipstick 32 to indicate one or more oil levels, as described in greater detail below.

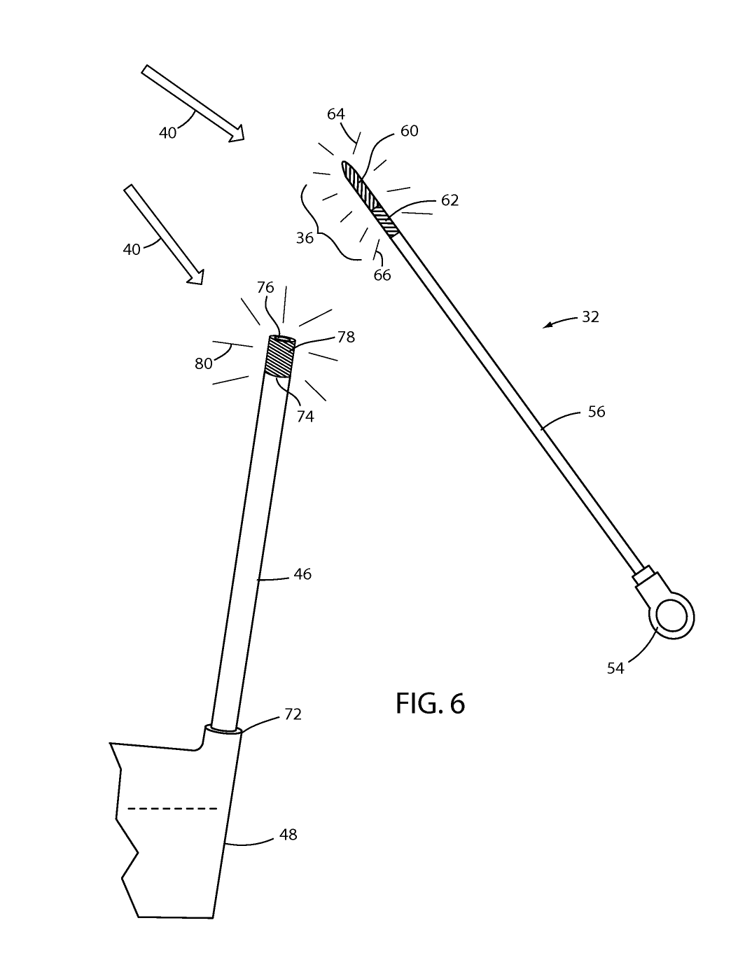

Referring to FIG. 6, the dipstick 32 and photoluminescent portion 36 are shown according to one embodiment. The dipstick 32 includes a handle 54 to enable manipulation of the dipstick 32 and a shaft 56 extending from the handle 54 and ending at a terminal end 58. The photoluminescent portion 36 is located at the terminal end 58 of the shaft 56 and may include one or more photoluminescent structures, exemplarily shown as a first photoluminescent structure 60 and a second photoluminescent structure 62. The first photoluminescent structure 60 and the second photoluminescent structure 62 may each extend longitudinally along the shaft 56 of the dipstick 32 and may each be located on at least one side of the shaft 56. In the presently illustrated embodiment, the first photoluminescent structure 60 is positioned closer to the terminal end 58 of the shaft 56 as compared to the second photoluminescent structure 62.

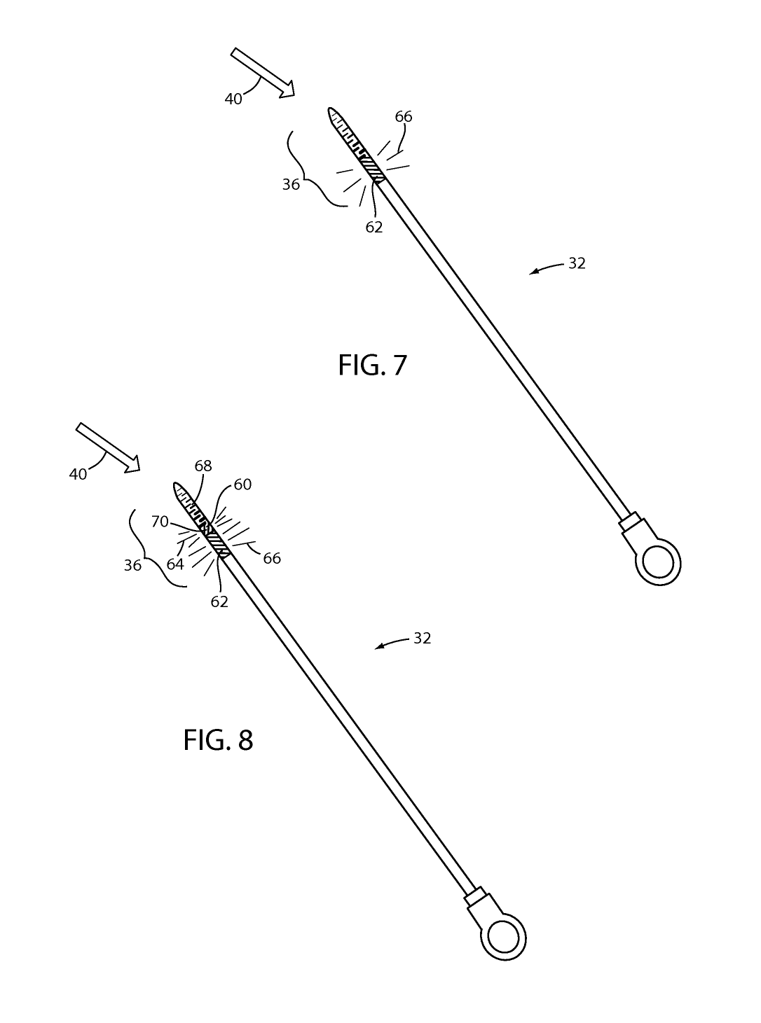

According to one implementation, the first photoluminescent structure 60 illuminates by converting the first light 40 into a second light 64 and the second photoluminescent structure 62 illuminates by converting the first light 40 into a third light 66. The second light 64 and the third light 66 may be visually distinct (e.g. different color) from each other to allow an user to discern the locations of the first photoluminescent structure 60 and the second photoluminescent structure 62, respectively. In the presently illustrated embodiment, the location of the first photoluminescent structure 60 on the shaft 56 may correspond to a low oil level whereas the location of the second photoluminescent structure 62 on the shaft 56 may correspond to a normal oil level. Depending on how much of the photoluminescent portion 36 is covered by oil, the first and second photoluminescent structures 60, 62 may vary in illumination, thereby allowing a user to determine whether the oil level is low or normal. For instance, when only the second photoluminescent structure 62 is not covered by oil, as shown in FIG. 7, a greater amount of the first light 40 will be transmitted thereto relative to the first photoluminescent structure 60. As a result, the luminosity of second photoluminescent structure 62 will tend to be substantially greater than the luminosity, if any, of the first photoluminescent structure 60, thereby informing a user that the oil level is normal. In contrast, when oil only covers a portion 68 of the first photoluminescent structure 60, as shown in FIG. 8, the luminosity of the uncovered portion 70 of the first photoluminescent structure 60 will tend to be substantially greater than the luminosity, if any, of the covered portion 68 of the first photoluminescent structure 60. Additionally, the luminosity of the uncovered portion 70 of the first photoluminescent structure 60 will tend to be substantially similar to the luminosity of the second photoluminescent structure 62. As a result, the relatively high luminosity of the uncovered portion 70 informs a user that the oil level is low and also provides a visual indication of how far away it is from the normal oil level. In response, the user may add oil to the oil reservoir 48 and take additional measurements until the oil level is normal, which is evidenced by a high luminosity of the second photoluminescent structure 62 relative to the first photoluminescent structure 60.

Referring back to FIG. 6, the tube 46 is shown coupled to an upper portion 72 of the oil reservoir 48 and may extend therefrom in a substantially vertical direction. The tube 46 may include a photoluminescent end 74 having an opening 76 through which the photoluminescent portion 36 of the dipstick 32 is received. Like the photoluminescent portion 36 of the dipstick 32, the photoluminescent end 74 may be configured to illuminate as a result of being excited by the first light 40. According to one embodiment, the photoluminescent end 74 may include at least one photoluminescent structure 78 configured to convert the first light 40 into a fourth light 80. With respect to the embodiments described herein, the conversion of the first light 40 may occur via the process of down conversion. For example, the first light 40 may be expressed as blue light or ultraviolet light whereas the second, third, and fourth lights 64, 66, 80 may each be expressed as red light, green light, blue light, or a combination thereof. According to one implementation, the second light 64 is expressed as red light, the third light 66 is expressed as green light, and the fourth light 80 is expressed as yellow light. Thus, in low visibility conditions, a user may easily locate and remove the dipstick 32, determine the oil level, and locate the opening 76 of the tube 46 to insert the dipstick 32 back into the tube 46.

Accordingly, a system for measuring fluid level has been advantageously provided herein. The system provides a dipstick having photoluminescent properties to allow a user to quickly and easily determine a fluid level based on the degree of illumination of the dipstick. As described above, the system is particularly beneficial for measuring the oil level of a vehicle engine. However, it should be appreciated that other applications, automotive or otherwise, may similarly benefit from the implementation of the system described herein.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A system for measuring fluid level, comprising:
a dipstick configured to be received in a fluid reservoir and having a photoluminescent portion; and
a light source operable to emit a first light to excite the photoluminescent portion;
wherein a fluid level is determined based on a degree of illumination of the photoluminescent portion when the dipstick is removed from the reservoir and the photoluminescent portion is exposed to the first light.

2. The system of claim 1, wherein the degree of illumination of the photoluminescent portion indicates that the fluid level is within one of a first fluid level and a second fluid level.

3. The system of claim 2, wherein the photoluminescent portion is further configured to convert the first light into a third light.

4. The system of claim 3, wherein the photoluminescent portion comprises a first photoluminescent structure configured to convert the first light into the second light and a second photoluminescent structure configured to convert the first light into the third light.

5. The system of claim 4, wherein the first photoluminescent structure and the second photoluminescent structure extend longitudinally along a shaft of the dipstick and the first photoluminescent structure is located closer to a terminal end of the shaft as compared to the second photoluminescent structure.

6. The system of claim 5, wherein the location of the first photoluminescent structure corresponds to the first fluid level and the location of the second photoluminescent structure corresponds to the second fluid level.

7. The system of claim 6, wherein the first light is expressed as blue light or ultraviolet light and the second and third lights are visually distinct from each other and are each expressed as red light, green light, blue light, or a combination thereof.

8. The system of claim 1, further comprising a tube coupled to the reservoir and having a photoluminescent end through which the photoluminescent portion of the dipstick is received into the reservoir, wherein the photoluminescent end of the tube is configured illuminate as a result of being excited by the first light.

9. The system of claim 1, wherein the fluid reservoir is positioned in a vehicle engine compartment and the light source is positioned under a vehicle hood.

10. A dipstick configured to be received in a fluid reservoir, comprising:
a handle; and
a shaft extending from the handle and having a photoluminescent portion configured to illuminate when excited by a first light, wherein a fluid level of the reservoir is determined based on a degree of illumination of the photoluminescent portion when the dipstick is removed from the reservoir and the photoluminescent portion is exposed to the first light.

11. The dipstick of claim 10, wherein the degree of illumination of the photoluminescent portion indicates that the fluid level is within one of a first fluid level and a second fluid level.

12. The dipstick of claim 11, wherein the photoluminescent portion is further configured to convert the first light into a third light.

13. The dipstick of claim 12, wherein the photoluminescent portion comprises a first photoluminescent structure configured to convert the first light into the second light and a second photoluminescent structure configured to convert the first light into the third light.

14. The dipstick of claim 13, wherein the first photoluminescent structure and the second photoluminescent structure extend longitudinally along the shaft of the dipstick and the first photoluminescent structure is positioned closer to a terminal end of the shaft as compared to the second photoluminescent structure.

15. The dipstick of claim 14, wherein the location of the first photoluminescent structure corresponds to the first fluid level and the location of the second photoluminescent structure corresponds to the second fluid level.

16. The dipstick of claim 15, wherein the first light is expressed as blue light or ultraviolet light and the second and third lights are visually distinct from each other and are each expressed as red light, green light, blue light, or a combination thereof.

17. A method of measuring a fluid level in a fluid reservoir, comprising the steps of:
providing a dipstick having a photoluminescent portion configured to illuminate when excited by a first light;
receiving the photoluminescent portion in the reservoir;
removing the photoluminescent portion from the reservoir;
exposing the photoluminescent portion to the first light; and
determining the fluid level based on a degree of illumination of the photoluminescent portion.

18. The method of claim 17, wherein the degree of illumination of the photoluminescent portion indicates that the fluid level is within one of a first fluid level and a second fluid level.

19. The method of claim 18, further comprising the step of positioning the reservoir in a vehicle engine compartment and emitting the first light using a light source positioned under a vehicle hood.

20. The method of claim 19, further comprising the step of providing a tube coupled to the reservoir and having a photoluminescent end through which the photoluminescent portion of the dipstick is received into the reservoir, wherein the photoluminescent end is configured to illuminate as a result of being excited by the first light.
